(19) United States
(12) Patent Application Publication
(10) Pub. No.: US 2016/0162560 A1
(43) Pub. Date: Jun. 9, 2016

(54) PROVIDING AN ELECTRONIC BOOK TO A USER EQUIPMENT

(71) Applicant: TELEFONAKTIEBOLAGET L M ERICSSON (PUBL), Stockholm (SE)

(72) Inventors: Simon MORITZ, Stockholm (SE); Calin CURESCU, Solna (SE); Göran ERIKSSON, NORRTÄLJE (SE)

(73) Assignee: TELEFONAKTIEBOLAGET L M ERICSSON (PUBL), Stockholm (SE)

(21) Appl. No.: 14/905,999

(22) PCT Filed: Jul. 3, 2013
(86) PCT No.: PCT/SE2013/050854

§ 371 Date: Jan. 19, 2016

(51) Int. Cl. G06F 17/30; H04L 29/08

(52) U.S. Cl. CPC G06F 17/30581; H04L 67/1095; G06F 17/30525

(57) ABSTRACT

In a method executable on a server a version of an electronic book is provided to a user equipment, the electronic book comprising media content provided as sequentially arranged sections and including at least one tag, each of which is being representative of an associated annotation, where each annotation comprises additional media content. The method comprise: identifying, in a request received from a first user equipment, a first version of an electronic book, at least one additional version of the electronic book, a first end user and the first user equipment as a user equipment on which an end user requires presentation of the electronic book; synchronizing the media content of the first version of the electronic book and the at least one tag with associated content of said at least one additional version of the electronic book, and identifying and transmitting, sequentially, to the first user equipment, media content of the first version of the electronic book together with any identified associated tag, wherein, in response to identifying a request received from the first user equipment indicating a selection of one of said tags, the method further comprises identifying and transmitting, to a preferred user equipment, an annotation associated with the selected tag, such that the annotation can be presented to the end user on the preferred user equipment. A method is also provided for generating tags and associated annotation such that each generated tag/annotation is selectable upon presentation of associated media content on a user equipment.

### TECHNICAL FIELD

This document disclose methods for handling tags and associated annotations in media content render able on a user equipment a server and a user equipment, as well as a server and a user equipment for executing such methods.

### BACKGROUND

Literature, including many types of information, provided in electronic form, such as e.g. as an electronically readable book or an audio book, is becoming more popular, much due to increasing use of electronic user equipment, such as e.g. smart phones and pads, and the relatively easy access these types of equipments provide to literature accessible in an electronic format.

Often, electronically available information is accessible in different versions, where one version may e.g. be a limited version of the original one, i.e. the content of the different versions differs. In addition, a readable version may have a corresponding audio book version. When rendering one version, it is handled totally independent from any other version.

In addition, the capabilities of a user equipment used for rendering or consuming one version of an electronic book provides limitations to how the content of the electronic book can be presented to a user. Furthermore, restrictions may also limit what can be rendered.

### SUMMARY

It is an object of the present document to address, or at least alleviate, at least some of the problems described above.

According to one aspect, a method executable on a server, of providing a version of an electronic book to a user equipment is provided, where the version comprises media content provided as sequentially arranged sections and including at least one tag, where each tag is being representative of an associated annotation, and where each annotation comprises additional media content. The method comprise: identifying, in a request received from a first user equipment, a first version of an electronic book, at least one additional version of the electronic book, a first end user and the first user equipment as a user equipment on which an end user requires presentation of the electronic book; synchronizing the media content of the first version of the electronic book and the at least one tag with associated content of said at least one additional version of the electronic book, and identifying and transmitting media content of the first version of the electronic book sequentially to the first user equipment, together with any identified associated tag. In response to identifying a request received from the first user equipment indicating a selection of one of said tags, the method further comprises identifying and transmitting an annotation associated with the selected tag, to a preferred user equipment, such that the annotation can be presented to the end user on the preferred user equipment.

An advantage with the method suggested above is that a user will be able to access media content of both a selected version of an electronic book, as well as one or more associated versions of the electronic book.

Upon receiving a request for selecting a preferred user equipment, either the first user equipment, or a second user equipment may be identified as a preferred user equipment.

According to another aspect, a method executable on a server of enabling enriching content of an electronic book is provided, where the electronic book is provided with media content provided as sequentially arranged sections. The method comprises: identifying a first version of the electronic book, a first user device on which an end user has initiated presentation of the electronic book, and the first end user, and identifying and transmitting, sequentially, to the first user equipment, media content of the first version of the electronic book. In response to identifying a user interaction executed at the first user equipment and associated with a section of the first version, indicative of associating a tag and an associated annotation with said section, the method further comprises associating the identified tag and an associated annotation with the selected section, such that, after a subsequent synchronization of the media content of the first version of the electronic book and the identified tag with associated media content of at least one additional version of the electronic book, the specified tag and associated annotation is presentable and selectable in association with presenting the selected section on the first version and the at least one additional version of the electronic book on a respective user equipment.

An advantage with the method suggested above is that a user will be able to enrich and contribute to the renderable media content of both a selected version of an electronic book, as well as one or more associated versions of the electronic book.

According to a first embodiment the synchronization is based at least partly on access rights registered for the first end user, while according to a second embodiment the synchronization is based at least partly on at least one of the following identified attributes: the first end user, the one or more additional versions of the electronic book, a group of end users.

Furthermore, the method may comprise a further step of increasing a counter associated with the first end user upon identifying a selection of an annotation previously associated by the first end user and selected by an end user other than the first end user, or decreasing the counter on the basis of the media content comprised in an annotation selected by the first end user and previously associated by an end user other than the first end user. Thereby, production, as well as consumption of tags and associated annotations can be encouraged.

According to yet another aspect a computer program comprising computer program code is provided, where the computer program code is configured such that when executed on a processor the alternative aspects suggested above.

According to yet another aspect, a computer program product comprising a computer readable storage medium is suggested, where the computer readable storage medium has the computer program as described above embodied therein.

According to yet another aspect, a server for providing an electronic book, to a user equipment is provided, where the electronic book comprise media content provided as sequentially arranged sections and including at least one tag, each of which is being representative of an associated annotation, where each annotation comprises additional media content. The server comprises a processor and a memory, where the memory comprises instructions executable by the processor, whereby the server is operative to: identify, in a request received from a first user equipment via a communication interface, a first version of an electronic book, at least one additional version of the electronic book and a first end user and the first user equipment as a user equipment on which an end user requires presentation of the electronic book; initiate synchronization of the media content of the first version of the electronic book and the at least one tag with associated content of said at least one additional version of the electronic book, and identify and sequentially transmit, via the communication interface, to the first user equipment, media content of the first version of the electronic book together with any identified associated tag. In response to identifying a request received from the first user equipment indicating a selection of one of said tags, the server is further operative to identify and transmit an annotation associated with the selected tag to a preferred user equipment via the communication interface, such that the annotation can be presented to the end user on the preferred user equipment.

The server may be further operative to identify either the first user equipment or at least one second user equipment as a preferred user equipment upon receiving a request for selecting a preferred user equipment.

According to another aspect a server for providing an electronic book to a user equipment is provided where the electronic book comprise media content provided as sequentially arranged sections and including at least one tag, each of which is being representative of an associated annotation, where each annotation comprises additional media content. The server comprise a processor and a memory, where the memory comprise instructions executable by the processor (1110a), whereby the server is operative to: identify, in a request received from a first user equipment via a communication interface, a first version of the electronic book, a first user equipment on which an end user has initiated presentation of the electronic book, and the first end user, and identifying and transmitting, sequentially, to the first user equipment, media content of the first version of the electronic book. In response to identifying a user interaction executed at the first user equipment and associated with a section of the first version, indicative of associating a tag and an associated annotation with said section, the server is further operative to associate the identified tag and an associated annotation with the selected section, such that, after a subsequent synchronization of the media content of the first version of the electronic book and the identified tag with associated media content of at least one additional version of the electronic book, the specified tag and associated annotation is presentable and selectable in association with presenting the selected section on the first version and the at least one additional version of the electronic book on a respective user equipment.

According to one embodiment the server is operative to perform the synchronization at least partly on the basis of access rights registered for the first end user, while according to another embodiment, the server is instead operative to perform the synchronization at least partly on the basis of at least one of the following identified attributes: the first end user, the one or more additional versions of the electronic book, a group of end users.

The server may further comprise a counter associated with the first user, the server being operative to increase the counter upon identifying a selection of an annotation previously associated by the first end user and selected by an end user other than the first end user, and to decrease the counter upon identifying a selection of an annotation being made by the first end user where the selected annotation is previously associated by an end user other than the first end user.

### BRIEF DESCRIPTION OF THE DRAWINGS

The objectives, features and advantages of the present document will be better understood through the following illustrative and non-limiting detailed description, with reference to the appended drawings, in which:

FIG. 1 is a flow chart illustrating a method executed in a server for providing media content to a UE, according to one embodiment.

FIG. 2 is a flow chart illustrating another method executed in a server for enabling enriching of media content from a UE, according to one embodiment.

FIG. 3 is a flow chart illustrating a way of changing usage when executing any of the methods as illustrated in FIG. 1 or 2.

FIG. 4 is a flow chart illustrating determination of access to services according to one embodiment.

FIG. 5 is a flow chart illustrating a way of notifying a UE of updated media content.

FIG. 6 is a schematic illustration of a synchronization procedure according to on embodiment.

FIG. 7 is a flow chart illustrating a process for management of media content according to one embodiment.

FIG. 8 is a system overview illustrating a system capable of executing the method according to any of FIG. 1-5.

FIG. 9 is a signaling scheme illustrating a process for adding an annotation to an electronic book, according to one embodiment.

FIG. 10 is another signaling scheme illustrating a process for presenting media content of an electronic book on a user equipment, according to one embodiment.

FIG. 11a is a block scheme illustrating a server, herein referred to an annotation server, according to a first embodiment.

FIG. 11b is a block scheme illustrating a server, herein referred to an annotation server, according to a second embodiment.

FIG. 12 is a flow chart illustrating a method executed at a user equipment for adding tags and annotations.

FIG. 13 is a flow chart illustrating a method executed at a user equipment for handling user content.

FIG. 14 is a flow chart illustrating a method executed at a user equipment for identifying, acquiring and presenting annotations.

FIG. 15 is a flow chart illustrating a method executed at a user equipment for handling user content.

FIG. 16 is a block scheme illustrating a user equipment capable of rendering tags an annotations, and optionally also of producing such tags and annotations.

### DETAILED DESCRIPTION

An electronic book is in the present context to be interpreted as any type of electronically storable content representing a piece of literature which is presentable on an electronic media presenting device e.g. in the form of text, still pictures, motion pictures, audio, either alone or in a combination, and may, without limiting to such types of electronic books, e.g. be provided in the form of an E-book or an audio book.

Different versions are in the present context to be interpreted as different media content which is stored and which can be rendered in the same format but where one version may differ from another e.g. by being of different length, i.e. one version is provided as a shortened version of the original version. Alternatively different versions may disclose a media content presented in two different formats, such as e.g. one version is presentable as a text and still picture version while in an alternative version the corresponding media content is instead presentable as audio. Consequently, when used hereinafter to describe different embodiments, different versions may have the same format or different format. Different versions may also contain the same literal content or differing content.

Tags are in the present context to be interpreted as any type of indicating means which can be used in, and presented together with, media content to indicate to an end user that by activating the tag an associated notification will be presented in a way which was determined when the notification was entered to the respective electronic book, e.g. visually, via audio or by a combination of both. The tag is typically chosen as a representative “header” having an appearance which is informative enough to give the end user a good picture of what additional data can be obtained by activating the tag. The tag may e.g. indicate a certain category, or content type, such as e.g. image, sound, map, or be more informative, such as e.g. image of a certain city center, sound of a certain motorcycle, map of a certain country. Such a tag may, without limiting to such types of tags, comprise a text string, an audible announcement, a picture, a symbol, or a combination thereof.

Annotations are in the present context to be interpreted as any type of media content which can be edited on a user equipment which is accessible to a media server, such as the one which will be described in further detail below. The annotations represent the actual content which is added to a version in order to enrich the original content, and may be in the form of text, still pictures, moving pictures, sound, or a combination thereof. Without limiting thereto, a typical annotation may be a text, a map, a movie, a melody which when linked to an associated, descriptive tag and a specific section of an electronic book, can be fetched from the media server and presented on a user equipment, selected as a user equipment which is preferred for such presentation.

Notifications are in the present context to be interpreted as indications provided to one or more end users, notifying these end users that an annotation which may be of interest to each of these end users is accessible. A notification may be provided to the end user through signaling presented visually, via audio or as a combination of both, on a user equipment.

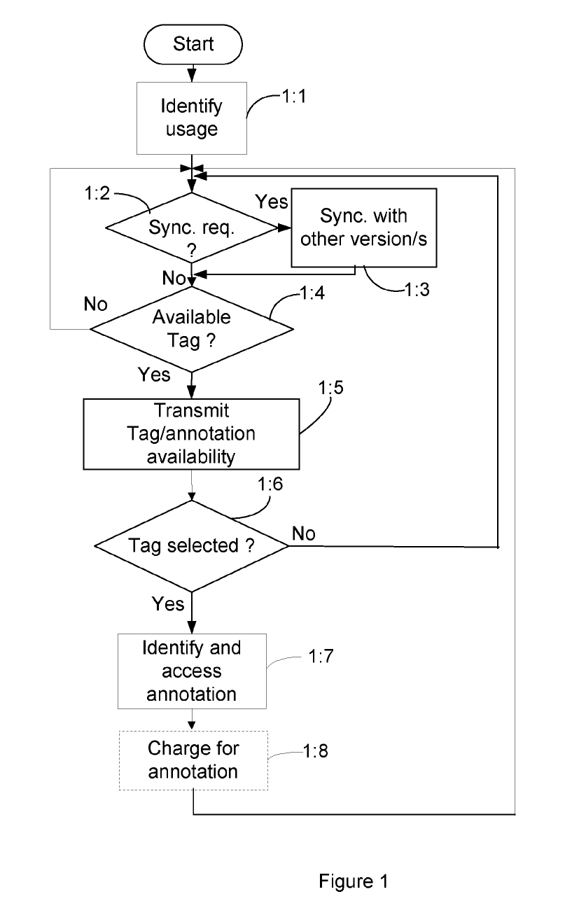

A method executable on a server, herein referred to as an annotation server, for providing a version of an electronic book to a user equipment, where the media content may have one or more annotations of one single or different types associated with it, which annotations may have been added during production of the electronic book, or after production, e.g. during presentation of the electronic book, or of another version of the electronic book, will now be described with reference to FIG. 1. This process may be referred to as a content consuming process.

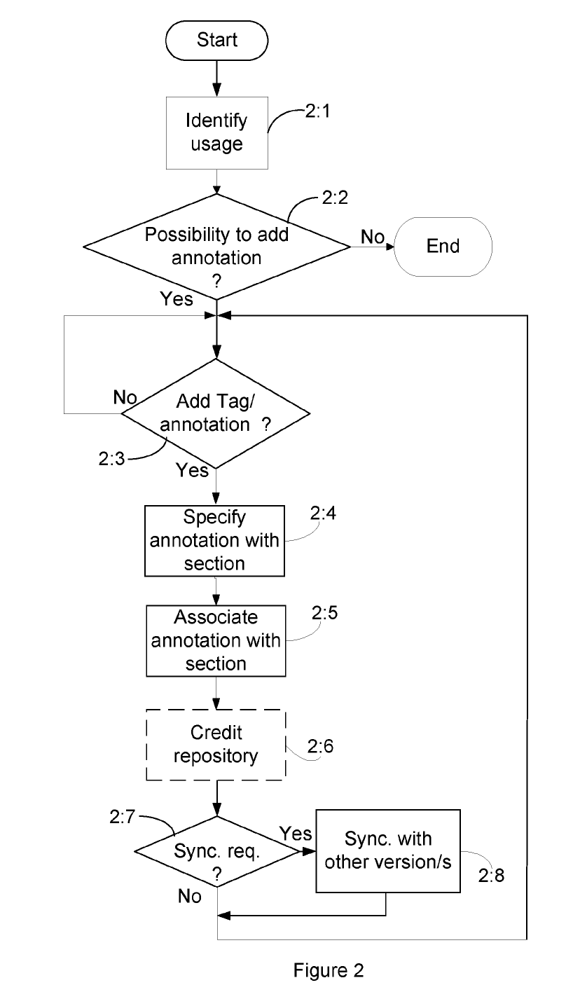

As a prerequisite for both FIGS. 1 and 2, an end user has successfully connected to a media server and a service for being able to access a desired version of an electronic book. Once the end user has initiated presentation of the version of the electronic book, content of the electronic book is successively fed to the end user in a conventional way, parallel to the feeding of tags, annotations and notifications. The method described The handling of the original content is out of the scope of this disclosure, and has therefore been omitted in the following figures. Therefore, while the method as described below with reference to FIG. 1 can be referred to as an online process, another process, which can be referred to as an offline process, for producing selected content of a selected version of an electronic book are executed in parallel.

In a first initial step 1:1, the end user specifies how to execute the requested service on a user equipment at his preferences by selecting a version of an electronic book, herein referred to as a used version, identifying himself as a user of the used version and of the used user equipment as presenting device. At this stage the end user may be presented with one or more associated and accessible versions of the electronic book and/or one or more alternative options of alternative user equipments on which the different versions, or certain types of annotations, can be presented to the end user in different, alternative ways. Typically such alternatives may have been registered in advance, e.g. by the end user, the distributor of the electronic book, the operator, alone, or in a combination. By being provided with such options, also when executing, or consuming the service, the end user may e.g. later switch user equipment or activate one or more further user equipments for the service, such that e.g. different types of annotations may be presented or rendered on different types of user equipments, each having different capabilities and advantages. The original media content provided in the electronic book may e.g. be of one media type while annotations provided in the media content may be of another media type. An end user may in such a scenario e.g. choose to watch a video having one or more annotations attached to it on a big screen TV, while choosing to watch an attached annotation on a mobile phone, or vice versa.

While an audio children book comprising image tags and associated annotations, constituting book illustrations, may be rendered on one and the same TV, in another scenario tags may be presented as informative highlighted text in an electronic text book, wherein by selecting such a tag, the end user triggers the presentation of the associated annotation on the same user equipment as used for rendering the electronic text book, or on another user equipment. As will be further specified below, an end user does not have to stick to a choice of user equipment for rendering original media content, tags and associated annotations, but may change to a more suitable user equipment later on, e.g. upon recognizing a type of annotation which is more suitable to render on another user equipment than the one presently used for the presentation.

At this stage it is also determined which versions to consider when executing a synchronization, including the used version. Such a consideration may be made automatically e.g. dependent on registered end user access rights, or on the basis of preferences, manually entered by the end user at this stage, or as a combination of both. In case of restricted access to the selected version of the electronic book this step may typically include verifying that the end user belongs to a user group, which have permission to access certain annotations only.

In a next step 1:2 it is determined if the identified versions are, to at least to some extent un-synchronized and, thus, whether any synchronization is required, in which case a synchronization between the identified versions is initiated, as indicated with another step 1:3. Whether or not to synchronize a used version of an electronic book to one or more other versions typically depend on what options the end user has made when identifying the usage at step 1:1, and/or any later updates to the identified usage. Following step 1:1, a synchronization of the media content of the identified electronic books will always be required. In addition, as will be described in further detail below, further updates of the usage will also result in a new synchronization.

Once the identified versions have been synchronized the end user will have the selected version presented on a used user equipment in a conventional manner and once a section of the media content of the selected version comprising at least one tag is identified the process described herein is continued with step 1:4. In step 1:4 it is determined whether any tag/annotation is available for a section of the media content, and, if so, the availability of an associated annotation for the user equipment and the end user is transmitted to the end user, as indicated in subsequent steps 1:5. The described availability determination will typically be executed in a separate process, also running in parallel to the described process, thereby allowing the end user to add, remove or switch to another user equipment at any time during presentation or consuming of a version of an electronic book. Such a process will be described in further detail below with reference to FIG. 4.

An annotation may be of a non-timed media type, which may comprise e.g. text, an image or location coordinates, or a timed media type, such as e.g. timed text, a timed slideshow, audio or a video. If e.g. an electronic book is of a timed media type, e.g. an audio book, each annotation associated with this version will be associated with a certain time point in the play out time of the media, such as e.g. at time 01:12:32 from the start of a presentation of an audio book a tag is notified to the end user, allowing the end user to have an associated annotation selected and presented by activating the tag. If on the other hand the electronic book is instead of a non-timed media type, the tags will instead be referenced by an orderable item of the electronic book, such as e.g. word nr. 25434 or paragraph 56 in the electronic book is provided with a tag.

As indicated in a next step 1:6 it is then a matter of the end user to determine whether he wants to have the annotation advertised or presented by activating the associated tag presented or not.

The end user may select to activate a respective tag, and thereby initiate presentation of the associated annotation, e.g. by interacting via a touch screen or a keyboard of the user equipment, or by using a voice command on a microphone of the same. In case a relevant user interaction of the tag is activated, the selected annotation is made available to the end user, such that it can be presented on the user equipment selected for such presentations, as indicated with step 1:7. Irrespective of how long the end user wishes to have the annotation presented, the process of FIG. 1 commences by again running a synchronizing process of the used version, if required, according to a predefined configuration and continues by awaiting and handling any further tag and associated annotation in chronological order.

Alternatively, as will be described in further detail below, the end user may, e.g. in association with step 1:6, select an alternative user equipment for presenting the selected annotation. If, on the other hand, the end user chooses not to render the annotation associated with the presented tag, the described process continues, starting with step 1:2, until another tag is identified, as the end user navigates forward or backward in the presented version.

Unless use of annotations are free of charge, the end user may also be charged for the selected use of an annotation, on a per annotation basis, as indicated in a step 1:8. Alternatively, this step is combined with a verification of a relevant subscription, which verifies the end user entitlement to access certain annotations at a certain rate. In such a case, the charging/verification may instead be executed prior to step 1:7.

Alternatively, a charging system may be based on contributions and consumption of annotations, such that a counter associated with a first end user is increased each time an annotation is added to an electronic book by the first end user, i.e. the counter is increased for each produced annotation, while each time the first end user is selecting, or consuming, an annotation entered by another end user the counter is decreased. Similarly, the counter associated with a first end user may be increased when another end user is consuming an annotation previously added by the first end user. Thereby an end user which is contributing by producing annotations may get corresponding “free” access to annotations provided by other end users.

For timed media electronic books, a default behavior may typically be for annotations to be presented when the play out of the electronic book reaches the time point where a tag has been inserted, while for non-timed electronic books, the user may instead be notified of a tag and associated annotation when a certain section of an electronic book is presented to the end user.

A method executed on the annotation server described above, allowing an end user to enrich the media content of an electronic book by editing the media content of a version of an electronic book by adding tags and associated annotations on a UE, will now be described in further detail below, with reference to FIG. 2. This process may be referred to as a content producing process. As already mentioned above, as a prerequisite for this embodiment, the end user has started with initiating a service which enables him, not only to render user original media content of the selected electronic book in a conventional way, but also to add annotations to the rendered media content, at desired locations.

In resemblance to FIG. 1, an end user wanting to access an electronic book identifies his intended usage in a step 2:1 by providing information which corresponds to the information provided in step 1:1 in FIG. 1. In the present scenario though, the end user also indicates that he wants to be able to add tags and annotations to the media content, i.e. to produce content. In case of restricted access to the selected version of the electronic book this step may typically include verifying that the end user belongs to a user group, which have permission to add annotations. Step 2:1 also includes initiating rendering of the media content to which tags and annotations are to be added.

As indicated with step 2:2 the described process terminates in case the end user is not allowed to add annotations, e.g. if the end user has selected a version of an electronic book which he has not access to add annotations into, typically after allowing the end user to try to select alternative, allowable requests. However, if the end user is authorized to enrich the selected version with annotations, the procedure continues by identifying and presenting media content and tag/annotation availability, i.e. any tag which is available to the end user during presentation of the respective media content.

The process then identify and transmits successive sections of the electronic book until a trigger of the end user to enrich the selected version by adding an annotation to a respective section is identified, as indicated in step 2:3. More specifically, adding a tag and associated annotation on a user equipment is initiated at the user equipment by activating such a request at a certain point in time, in case of timed media type, or at a certain location of rendered media content, in case of non-timed media type. Consequently, reception of such a request at the annotation server initiates addition of a tag and annotation. More specifically, the end user may e.g. activate a certain section in an electronic book by activating a touch screen or a keyboard or via voice recognition or any other sound recognition means, such as e.g. recognition of a certain pattern of tappings on a touch screen, after which the end user specifies a tag and an associated annotation which may include editing the selected content via any suitable user interface, where the editing as such is out of scope of this disclosure. This is indicated with step 2:4.

In a next step 2:5 the tag and associated annotation are associated with the selected section of the rendered electronic book, i.e. the tag and associated annotation are linked to the required section of the media content of the electronic book. As a result of the association, after a subsequent synchronization, the tag and annotation will be accessible, not only from the presently rendered version but also from other registered, associated versions.

According to one embodiment, addition of annotations may be encouraged by crediting a counter, operating as an end user repository, each time an annotation is added to an electronic book by the end user, as indicated in an optional step 2:6. The sum in the end user repository may later entitle the end user access to other annotations by debiting the repository accordingly, as an alternative to monetary charging of the end user, as indicated in step 1:8 of FIG. 1.

As indicated in FIG. 2 the process continues by executing a synchronization process, for versions which are registered, if required, due to the added annotation, and continue to process more requests for further annotations, if any.

It is to be understood that the process described above with reference to FIG. 2 will typically run in parallel to the process described with reference to FIG. 1, such that the end user may, whenever required, add an annotation to an electronic book, while having the electronic book presented to him, i.e. while consuming the electronic book.

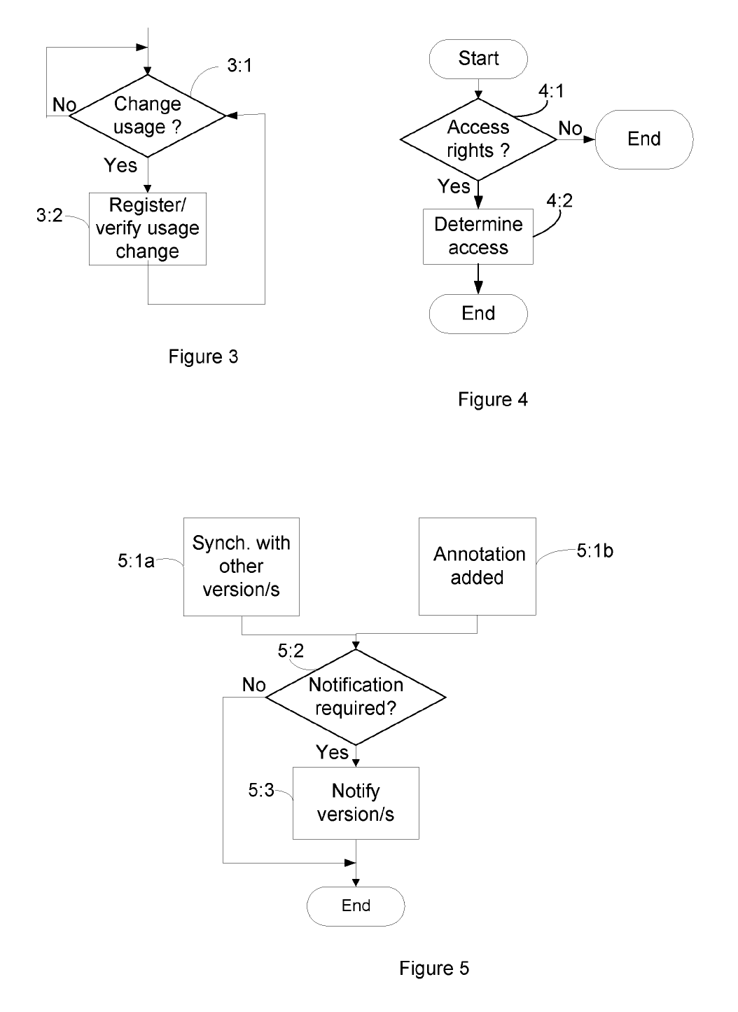

As already indicated above an end user consuming an electronic book, i.e. executing any or both of the processes described above may at any time choose to change the usage of the electronic book, e.g. by adding or removing a user equipment, or switching user equipment used for presenting media content, tags and annotations, changing versions to be updated or changing user groups which are to have access to annotations. Such a process, executed in the annotation server, is illustrated in FIG. 3 where in a first step 3:1 a required usage change registered at a user equipment is recognized at the annotation server as a request received by the annotation server, and, if required, this also includes a verification, of the identified usage change, as indicated with a subsequent step 3:2.

It has also been indicated above that rules and/or rights may be used for determining accessibility to annotations and/or rights to add certain annotations into certain versions of electronic books may be restricted to certain end users or end user groups. Such a process, may form part e.g. of a step of FIG. 1 or 2, such as e.g. step 1:5 or 1:7 of FIG. 1 or step 2:2 of FIG. 2, as described below with reference to FIG. 4.

In step 4:1 it is determined if an end user has access to annotations of a selected version of a chosen electronic book, or has access rights which allow to add annotations under the selected conditions. Based on predefined rules and access rights it is determined whether the usage required by the end user should be allowed or denied. More specifically a rule engine may determine whether an annotation associated with a selected tag shall be accessible to the end user, or if a certain type of annotations can be added by the end user. Alternatively, the rule engine may identify an alternative version of an annotation, such as e.g. a simplified version which can be presented on the user equipment presently used for presenting annotations. The access rights applied for such a purpose may e.g. depend on monetary conditions and/or user group memberships, such that e.g. end users being members of a certain user group have full or somehow limited access to a certain type of annotations. If an annotation associated with an identified tag is “approved” by the described process, the tag is presented in a form available at the selected user equipment, thereby making the associated annotation accessible to the end user. More specifically, one access rights have been verified in step 4:1 the specific access rights are determined in step 4:2.

The process described above with reference to FIGS. 1 and 2 updates relevant tags and annotations for relevant versions and user equipments at step 1:3 and 2:8, respectively, i.e. when different versions are synchronized. Which versions to synchronize and which end users that should have new notifications presented on their registered user equipments depends on the settings made in step 1:1 or 2:1, respectively, in the same figures, or of usage changes registered in step 3:2 of FIG. 3.

In addition, the described method may also be configured such that a user equipment registered for use of the described service is being notified of any new tag/annotation that is inserted into a relevant version. Such a notification may e.g. be presented to the end user in association with presenting a section of text of an e-book, notified as an audio notification on an audio book, or presented on a user equipment, specially registered only for this purpose.

FIG. 5 illustrates a process for handling such notifications, where step 5:1a corresponds to step 1:3 or 2:8 of FIG. 1 or 2, respectively, i.e. the notification process, here represented by step 5:2 and 5:3, is triggered by the synchronization. Alternatively, as indicated with alternative step 5:1b, notifications may be initiated each time a notification is added to a version, i.e. associated with a section of media content, where there is at least one additional end user and/or user equipment registered for receiving notifications, according to step 2:8 in FIG. 2. According to step 5:2 any of the triggers mentioned above is followed by a determining of whether any notification is required or not, by checking applicable rules registered end users for and in case at least one notification is required, notifications are provided to the respective version/s of electronic book/s, s indicated in subsequent step 5:3.

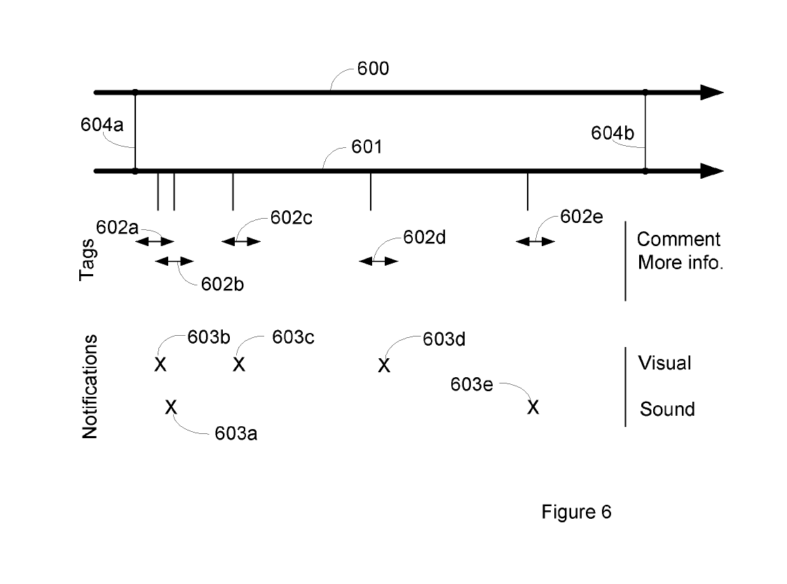

The synchronization procedure mentioned above will now be described in further detail with reference to FIG. 6. FIG. 6 is illustrating a time line or playtime 600 of a timed format, associated with a first version, of an electronic book such as e.g. an audio book, while corresponding media content of a non-timed format of a second version of the electronic book, e.g. an E-book, is arranged as consecutive sections, and defined as an ordered sequence 601 of e.g. words or paragraphs, where the time line 600 has a bijective relation to the ordered sequences 601.

A synchronization process may be triggered from any of the formats applied at any time, wherein, at synchronization, tags and associated annotations added after the last synchronization was executed will be synchronized, thereby making them available as selectable annotations for each version of the respective electronic book involved in the synchronization. In FIG. 6 a number of tags 602a,602b,602c,602d,602e of two different types, here referred to as comments, such as e.g. short text information, or more information, such as e.g. more informative text information, and associated annotations 603a, 603b,603c,603d, 603e are identified between the two synchronization events 604a,604b. As indicated in FIG. 6 a notification, which is either of a visual format, such as e.g. text, picture, or has a sound format, is triggered by each tag/annotation. A notification may also be arranged as a combination of both formats. At synchronization point 604b, all tags arranged along the ordered sequence 601 are synchronized against the time line 600 and its non-timed format via the bijective relation, such that e.g. word nr. 14134 of the ordered sequence 601 is synchronized to time point 01:23:45 of time line 600. During a synchronization between two or more versions the bijective relation is registered as a valid relation for all registered combinations of end users and versions. Thereby, any such combination will have the respective tag/annotation presented when the respective section is presented.

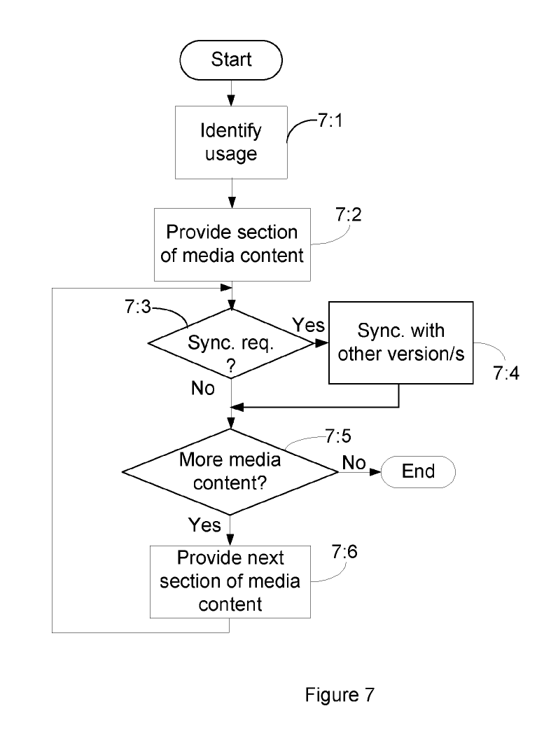

A method of processing media content will now be described below with reference to FIG. 7. Such a process is typically executed in the annotation server or in a separate server, connected to the annotation server, such that tags and annotations can be linked to associated media content and as long as different versions of media content can be synchronized. In a first step 7:1, which corresponds to step 1:1 and 2:1 in FIGS. 1 and 2, respectively usage is identified. Once usage has been identified, including selection of a version of an electronic book to be rendered, a first section of media content is acquired from memory storage and provided to the user equipment on which the selected media content is to be rendered, as indicated in step 7:2. In a next step 7:3 it is determined whether synchronization is required, i.e. due to a timing, or other specific trigger, a synchronization of the rendered version is required. In case synchronization is required, e.g. due to a notification executed in another related version of the electronic book, such a synchronization is executed in step 7:4. In a next step 7:5 it is determined if the electronic book has reached the end. If this is the case the process is ended, otherwise a next section is acquired and provided to the user equipment. It is to be understood that the synchronization event described above may be executed in another order than suggested in FIG. 7.

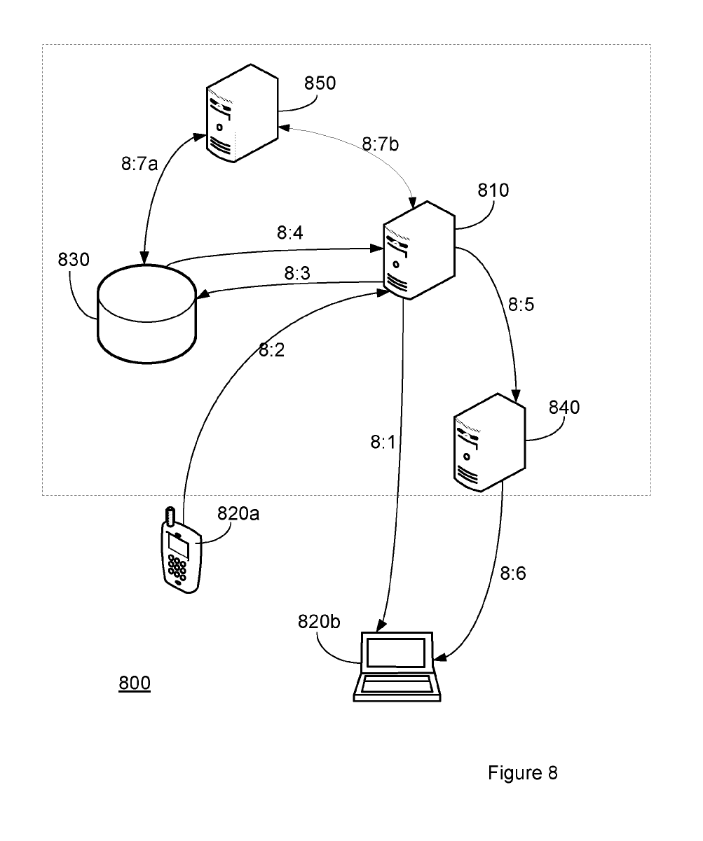

A system capable of presenting different versions, such as e.g. an E-book or an audio book, of the same “electronic book”, on suitable user equipments according to one embodiment will now be described in further detail with reference to FIG. 8. It is to be understood that, for illustrative purposes, the described system comprise a plurality of separate entities, but that one or more, or even all of these entities may alternatively be arranged as integrated parts, or even as one single apparatus.

The system 800 of FIG. 8 comprises an Annotation Server 810, which is capable of managing annotations which are linked to one or more versions of electronic books and serving user equipments 820a, 820b, which in the present example are represented by a mobile telephone and a laptop, respectively, each of which are capable of rendering media associated with one or more versions and formats of different types of electronic books, as well as adding annotations to presented media content. Presentation of media content, here on user equipment 820a, is illustrated with step 8:1, while adding an annotation, here on user equipment 820b, is illustrated with step 8:2.

A user equipment, such as the one described above, may be adapted to present anything from one single version to a number of different versions of an electronic book, which content can be presented either as timed or non-timed media of different types, such as e.g. as one type, or as a combination of text, audio, video. More specifically, a user equipment may be configured to request and execute insertion of an annotation into a specific format, when presenting a version having that format, by instructing the annotation server to insert an edited or selected annotation into a relevant location/section.

The annotation server 810 is configured to store such created annotations in an annotations and metadata database 830 when they are created, for later retrieval by the annotation server 810, as indicated with step 8:3, and to get annotations, stored in the annotations and metadata database 830, upon request, i.e. when a tag/annotation has been selected and is to be presented on a user equipment, as indicated with step 8:4. Alternatively the annotations and metadata database 830 may be arranged as an integrated part of the annotation server. The annotation server 810 is also capable of handling synchronization between different versions of an electronic book, whenever required, thereby associating annotations from different versions with each other. In addition, the annotation server 810 typically comprises functionality for identifying user equipments on which a specific media, incl. annotations, can be presented, i.e. to determine whether a certain user equipment have the capabilities for presentation of the requested annotation, and, if that is the case, to provide for presentation on that user equipment.

As mentioned previously, the annotation server 810 may also be configured to announce new annotations to an end user consuming an electronic book. In the present embodiment, this is executed via a separate node, here referred to as a Subscriber hub, or a Publisher 740, in steps 8:5 and 8:6. Alternatively, such a function may be configured as an integrated part of the media annotation server 810. An end user may respond to an announcement, as provided in step 8:6, by requesting an annotation to be rendered on the user equipment, if a respective version of the electronic book is already activated, or by selecting to have the electronic book and possibly also the annotation presented.

The system 800 also comprises a media format translator 850 which is capable of translating an annotation entered into a specific location/section in a first format into another version/format, as indicated in step 8:7a or 8:7b. Alternatively, also the media format translator 850 may be configured as an integrated part of the annotation server 810.

It is to be understood that the steps of FIG. 8 are not to be construed as steps which need to be performed in the specific order given by the references, but merely as an indication of possible actions or steps which may be initiated in a system, such as the described one.

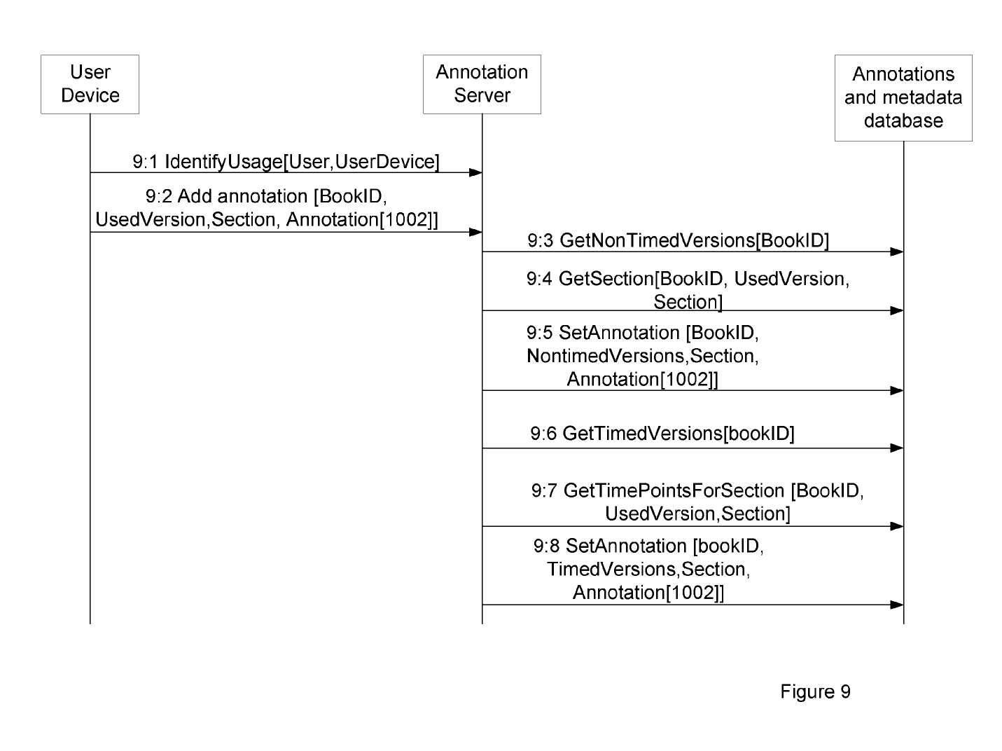

A method for adding, or producing, a tag and associated annotation during presentation of an electronic book, will now be described in further detail with reference to the signaling scheme of FIG. 9, where, as a prerequisite an end user has identified usage, as indicated in step 1:1 of FIG. 1, or step 2:1 of FIG. 2, thereby also enabling two or more user equipments to be synchronized with each other. As indicated above, also different restrictions, such as e.g. restriction of versions to be considered, may have been specified at such a preceding step.

In a first step 9:1, which can be seen as a step for specifying a specific service, an end user identifies his intended usage to an annotation server, by identifying himself as an end user and the user equipment used for the service. Although step 9:1 only describe the two mentioned parameters, the end user may at the same time also identify other user specific parameters, such as e.g. a plurality of additional user equipments to be used for the service and/or specifications on one or more user groups which are to be considered when synchronizing different versions of electronic books.

As already mentioned above, it is to be understood that the identification step described with step 9:1 may be repeated at any time during use of the described service, either by updating all parameters or only one or some of them, such that e.g. a user equipment is selected as a user equipment to be used for the respective service.

In a next step 9:2, an end user of a user equipment, has put together an annotation via any suitable user interface of the user equipment, e.g. by defining an electronic map as an annotation and by naming an associated tag e.g. “Map of Europe”. The annotation server identifies the Add annotation request provided from the user equipment, comprising a number of parameters. In the present example defining: an electronic book, with a bookID, and the specific version, UsedVersion, which is used by the end user, the specific place in the version where the annotation is inserted, indicated with Section, any data, here indicated as Annotation, necessary to identify and access the added annotation itself. The annotation is typically a link allowing a specific annotation to be accessible when rendering the associated media content. The annotation server responds to such a request by making an inquiry for any registered non-timed versions associated with bookID from the annotations and metadata database, as indicated with step 9:3, i.e. determining which versions to consider for the update of the annotation. It is to be understood that in the present example, no selection of non-timed or timed versions is indicated, but is considered to have been made e.g. as a default selection for the end user. In an alternative embodiment, however, such a step may be executed manually by the end user, e.g. in association with executing step 9:1.

In a next step 9:4 the annotation server makes an inquiry for the relevant section, Section, in UsedVersion, i.e. a part of the original user content and in a subsequent step 9:5, here referred to as SetAnnotation, the annotation server inserts the annotation into each identified non-timed versions. More specifically, one or more relevant non-timed versions are provided with a link to the annotation, which is inserted into the respective relevant section. It is to be understood that this is always done for at least one non-timed or timed version, i.e. the used version, and in case of synchronization, as is the case in the present example, also for one or more additional versions.

In steps 9:6-9:8 procedures for handling identified timed versions, which correspond to steps 9:3-9:5 as described above, are also executed, in order to complete the synchronization. Once step 9:8 has been completed, an annotation has been inserted into the UsedVersion, as well as all other identified versions which are to be taken into consideration. The described steps, or relevant steps, if only timed or non-timed versions are to be considered, are repeated each time an end user wants to add another tag and annotation to a used version, and may be invoked only for updating a version or while using a version for presentation, and realizing that a tag and associated annotation should be added to a specific section of the used version. In addition, although not explicitly indicated in FIG. 9, the described process may also include initiation of a notification of the added annotation to one or more end users, according to predefined rules on when to provide notifications to the respective end users.

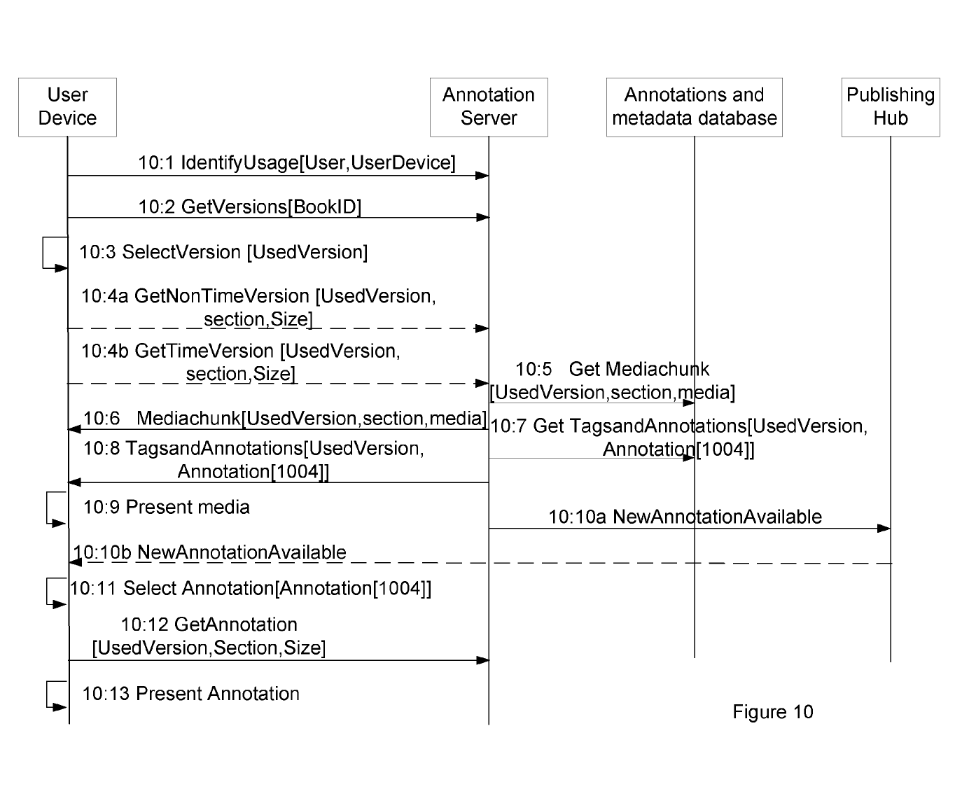

Another method illustrating how a tag and an associated annotation previously added to media content can be selected and presented will now be described in further detail with reference to FIG. 10 where the same prerequisite as for FIG. 9 applies, i.e. the respective user equipment/s which is/are to be applied for the service has already been identified prior to the first step of FIG. 10.

In a first step 10:1, usage is identified, in the same manner as in step 9:1 of FIG. 9. Similarly to step 9:1, this step may be repeated for all parameters or only some parameters also during use of the service.

In a subsequent step 10:2, versions available for a certain BookID is requested from an annotation server, and in a subsequent step 10:3 an end user selects a preferred version, UsedVersion from the available versions for presenting or rendering content, including any tags and annotations already attached thereto. Based on the identified usage, a request for a relevant section of either a non timed version is sent from the user equipment to the annotation server, as indicate in a step 10:4a, or of a timed version, as indicated in another alternative step 10:4b, depending on what type of version that was chosen in step 10:3. In response media content, representative of the selected section, here referred to as mediachunk, is acquired from the annotations and metadata database, in a step 10:5, and provided from the annotation server to the user equipment in another step 10:6, and any available tags and annotations associated with the respective section are acquired from the annotations and metadata database in step 10:7, and provided from the annotation server to the user equipment in a subsequent step 10:8. The retrieved mediachunk and associated and available tags are presented at the user equipment, as indicated with step 10:9. Steps 10:4a-10:9 may successively be repeated section for section as the end user has the selected version presented to him.

Any new annotation is triggered at the annotation server and signaled to a publishing server in step 10:10a, and, in case a notification feature is enabled at the user equipment, the new annotation is notified to the user equipment, as indicated with optional step 10:10b. As already mentioned, the notification process may involve also other user equipments. It is to be understood, that even though the publishing hub is illustrated as a separate unit in FIG. 10 it may alternatively be configured e.g. as an integrated part of the annotation server. New annotations may be notified to a user equipment e.g. after an end user has updated his user group by adding end users to a service.

In a next step 10:11 the end user selects one of the annotations, here as provided in step 9:6, of FIG. 9 or notified in step 9:10b. In a subsequent step 10:12 the selected annotation is requested from the annotation server, requesting it from the annotation server, in step 10:13 and providing it to the user equipment in subsequent step 10:14, and in step 10:15, the annotation is presented on the user equipment presently selected for the respective type of presentation.

The described steps may be repeated for further sections of the used version and further notifications, until the end user terminates the service. It is to be understood that as an alternative to one or more of the steps mentioned above where the user equipment is requesting any of media chunks, tags or annotations, any such requested content may be already stored on a cache of the user equipment and in such a case the respective content will be acquired from the cache instead of from the annotations and metadata database.

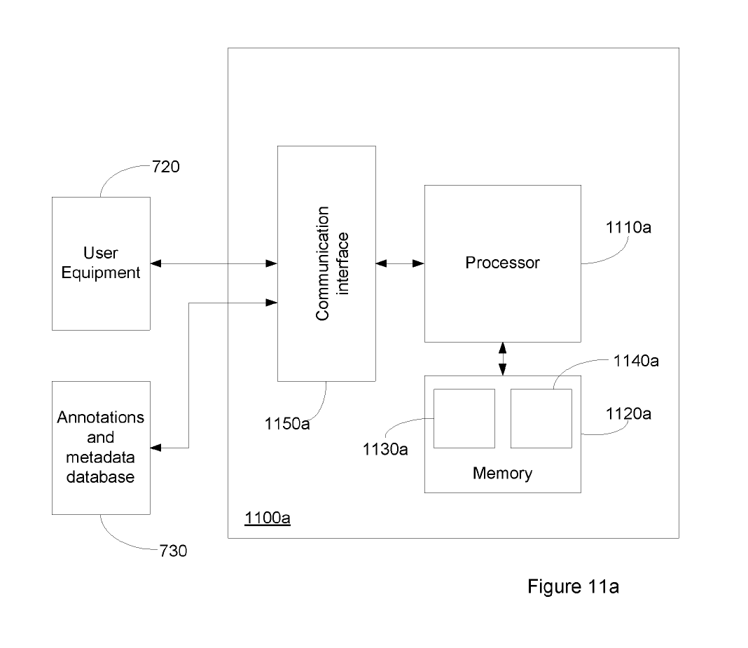

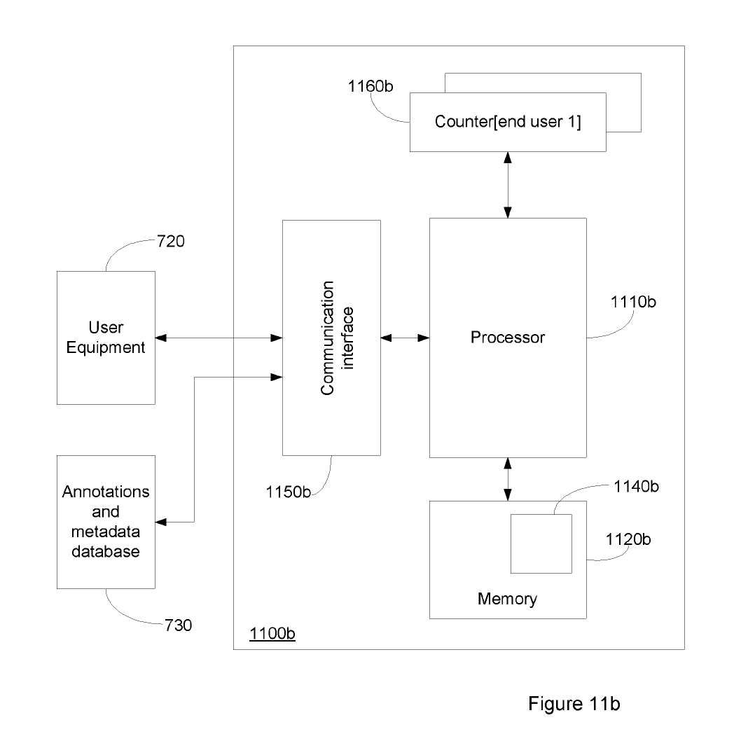

An annotation server which is capable of executing any of the methods described above will now be described in further detail with reference to FIG. 11a. The server 1100a comprise one or more processors, here represented by processor 1110a, and a memory 1120a, where the memory 1120a comprise instructions 1130a executable by the processor 1110a such that the processor 1110a is operative to execute the method as described above with reference to any of FIG. 1-5 or 7. The processor 1110a may be e.g. a central processing unit (CPU), multiprocessor, microcontroller, digital signal processor (DSP), or an application specific integrated circuit which is capable of executing software instructions stored in a memory. A data memory 1140a is also provided, either as forming part of memory 1120a, or as a separate memory, for storing and reading content data, tags and annotations during execution of software instructions by the processor 1110a.

The memory 1140a can be any combination of read and write memory (RAM) and read only memory (ROM). The memory 1140a may also comprise persistent storage, which, for example, can be any single one or combination of magnetic memory, optical memory, solid state memory or even remotely mounted memory. The annotation server 1100a of FIG. 11a also comprises a communication interface 1150a, via which the processor is capable of communicating with user equipments 720 and external units, which are not integrated within the annotation server 1100a, such as an annotation and metadata database 730.

More specifically, according to one embodiment, the memory comprises instructions executable by the processor, whereby the annotation server is operative to:—identify, e.g. in a registration module, a first version of an electronic book, at least one additional version of the electronic book, a first end user and the first user equipment as a user equipment on which an end user requires presentation of the electronic book, in a request received from a first user equipment; synchronize, e.g. in a synchronization module, the media content of the first version of the electronic book and the tag/s with associated content of the additional version/s of the electronic book, and Identify, e.g. in an identifying module, and sequentially transmitting media content of the first version of the electronic book to the first user equipment via the communication interface, together with any identified associated tag. In addition the annotation server may be operable to identify, e.g. in the identifying module, and transmit, via the communication interface an annotation associated with the selected tag to a preferred user equipment, such that the annotation can be presented to the end user on the preferred user equipment, in response to identifying a request received from the first user equipment indicating a selection of one of the tags. The annotation server may also be operative to handle counters associated to separate user equipments as suggested herein, e.g. in a counting module.

An annotation server which is capable of executing any of the methods described above according to a second embodiment which is implemented as hardware logic, will now be described in further detail with reference to FIG. 11b, where server 1100b comprise a processor 1110b, which alternatively may be referred to as a processing unit, a memory 1120b, and a communication interface 1150b. The processor 1110b is configured to identify a specific version of an electronic book; the end user executing the service and a used user equipment on which the end user has initiated presentation of the electronic book, upon receiving such a request via a communication interface 1150b. The processor 1110b is also configured to initiate synchronization of the media content of the used version of the electronic book and at least one associated tag with associated content of at least one additional version of the electronic book. In addition, the processor 1110b is configured to identify and, sequentially, transmit, media content of the first version of the electronic book together with any identified associated tag, to the first user equipment 720, via the communication interface 1150b, and to respond to the identifying of a request received from the user equipment 720, indicating a selection of one of the tags made at the first user equipment 720 by identifying and transmitting an annotation associated with the selected tag, via the communication interface 1150b, to a preferred user equipment.

The processor 1110b is further configured to identify at least one second user equipment as a preferred user equipment, upon receiving such a request.

In order to be able to present inserted annotations to a user the processor 1110b is also configured to identify various information, including: a first version of the electronic book, a first user equipment on which an end user has initiated presentation of the electronic book, and a first end user, in a request received from a first user equipment. The processor 1110b is also configured to, sequentially, identify and transmit, to, media content of the first version of the electronic book to the first user equipment, wherein, in response to identifying, via the communication interface, a user interaction executed at the first user equipment and associated with a section of the first version, indicative of associating a tag and an associated annotation with said section, the processor 1110b is also configured to: associate the identified tag and an associated annotation with the selected section, such that, after having initiated a subsequent synchronization of the media content of the first version of the electronic book and the identified tag with associated media content of at least one additional version of the electronic book, the specified tag and associated annotation are made presentable and selectable in association with presenting the selected section on the first version and the at least one additional version of the electronic book on a respective user equipment.

The processor 1110b is configured to perform the synchronization at least partly on the basis of access rights registered for the first end user and at least partly on the basis of at least one of the following identified attributes: the first end user, the one or more additional versions of the electronic book, a group of end users.

The server may also comprise a counter 1160b associated with the first user, wherein the processor 1110b is configured to increase the counter upon identifying an association of a tag and an associated annotation initiated by the first end user, and to decrease the counter upon identifying such a presentation. In addition, or alternatively, the processor 110b1 may be configured to increase the counter upon identifying a selection of an annotation previously associated by the first end user and selected by an end user other than the first end user, and to decrease the counter upon identifying a selection of an annotation being made by the first end user where the selected annotation is previously associated by an end user other than the first end user.

A user equipment capable of connecting to an annotation server, such as any of the ones described above may be configured as e.g. a computer, a laptop, a pad or a cellular telephone. A user equipment configured to add tags and annotation to an electronic book is provided with a suitable user interface, enabling a user e.g. to as a URL link, to upload a file, such as e.g. a text, image and/or sound file and indicate that such a tag/annotation is to be associated with a certain section in an electronic book. In addition, the user may have the option of also adding a specific notification to be used for notifying other users of the added tag/annotation. Such an annotation may be selected in the form of a specific text, sound, image, light, either alone or in a combination.

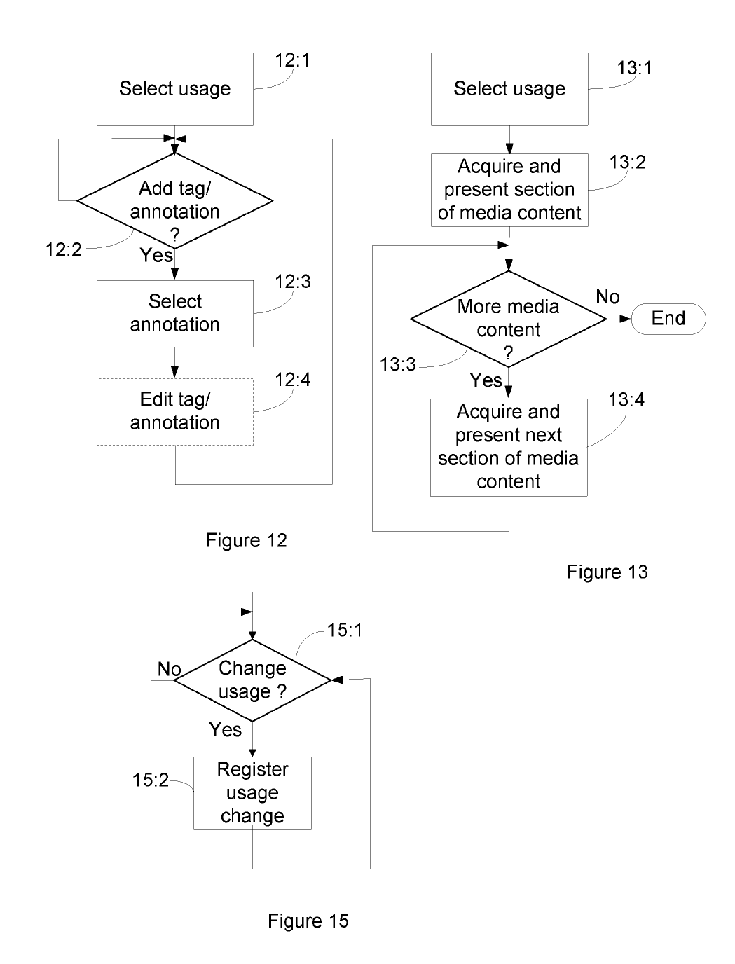

A method for enriching an electronic book will now be described with reference to FIG. 12, where in a first step 12:1 a user who has accessed an electronic book in a conventional manner may select usage as already described above, i.e. by selecting various user equipments for rendering different types of content. In a next step 12:2 it is determined whether insertion of a tag and associated annotation is selected. This may e.g. be done by tapping on a certain section of text of a rendered version of an electronic book at a display of the user equipment, and in a next step 12:3 the user may continue by selecting the annotation accordingly, e.g. by selecting a URL, as suggested above, which is thereafter associated with the indicated section. This step may, depending on the type of annotation and capabilities of the user interface, also include editing of the annotation, e.g. in case the annotation is a plain text, as indicated with optional step 12:4.

FIG. 13 is a flow chart illustrating how a user equipment, when rendering or consuming an electronic book, can acquire media content, either from an annotation server, or, in order to reduce the delay when rendering the electronic book, from a cache of the user equipment.

In a first step 13:1 preferences for the usage are selected by the user, as already described in this disclosure. In a next step 13:2 a first section of media content of the electronic book is acquired and presented to the user via a suitable presentation means, which may include presentation via a display, a loudspeaker or a combination thereof. Sections are then successively provided to the user, as indicated with subsequent steps 13;3 and 13:4.

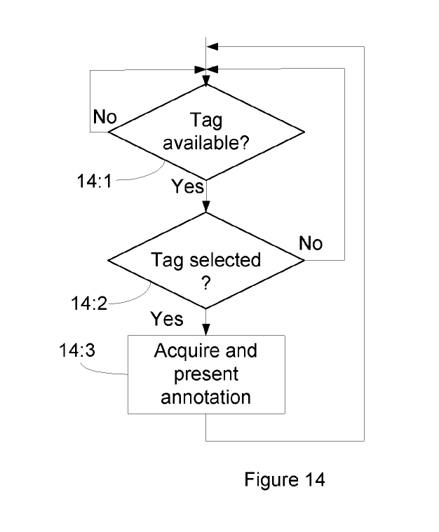

The flow chart of FIG. 14 illustrates a method which is running in parallel with the method as described above with reference to FIG. 13, for handling tags and annotations. In a first step 14:1 it is determined for a rendered section of media content, whether there is at least one tag available for that section. In case there is a tag available and this is selected by a user, e.g. by tapping on it on the display of the user equipment, or e.g. by giving an instruction orally, in case of rendering an audio version of the electronic book. This step is indicated as step 14:2 in FIG. 14. The annotation associated with the selected tag is acquired and presented, as indicated in step 14:3 and the process is repeated, until the last section has been presented.

FIG. 15 is a flow chart illustrating a process which is also running in parallel to the processes described above with reference to FIGS. 13 and 14, for enabling a user to change usage whenever this is found to be required. As already mentioned above, this may e.g. include switching to another version of an electronic book, or changing or adding a user equipment on which media content and/or tags and annotations are to be rendered. In a first step a usage change selected by a user on its user equipment is registered, which results in the usage change being sent to the annotation server for registration, as indicated in step 15:2.

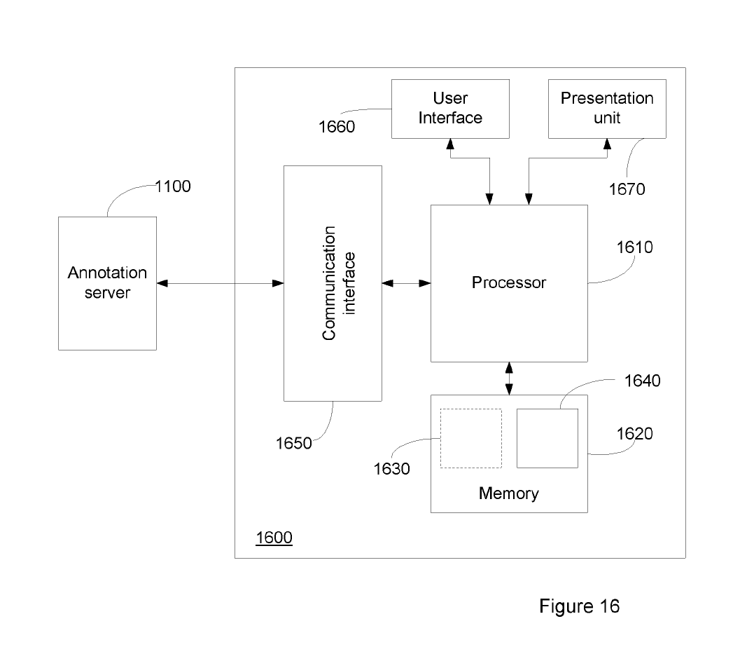

FIG. 16 is a block scheme illustrating a user equipment 1600 comprising a processor 1610. The user equipment 1600 comprises one or more processors, here represented by processor 1610, and a memory 1620. In case of a software implementation, the memory 1620 also comprises instructions 1630 executable by the processor 1610 such that the processor 1610 is operative to execute the method as described above with reference to any of FIGS. 12-15. The processor 1610 may be e.g. a central processing unit (CPU), multiprocessor, microcontroller, digital signal processor (DSP), an Application Specific Integrated Circuit (ASIC), or an application specific integrated circuit which is capable of executing software instructions stored in the memory. A data memory 1640 is also provided, either as forming part of memory 1620, or as a separate memory, for storing and reading content data, tags and annotations.

The memory 1640 can be any combination of read and write memory (RAM) and read only memory (ROM). The memory 1640 may also comprise persistent storage, which, for example, can be any single one or combination of magnetic memory, optical memory, solid state memory or even remotely mounted memory. The user equipment 1600 of FIG. 16 also comprises a communication interface 1650, via which the processor is capable of communicating with an annotation server 1100 and any external unit (not shown) from which an annotation may be linked to an electronic book. In addition, the user equipment 1500 comprises a user interface 1660, such as e.g. a touch screen, a key board or a combination thereof, and one or more presentation unit 1670, such as e.g. a display, a loudspeaker, alone or in combination.

More specifically, according to one embodiment, the memory 1620, comprises instructions 1630, executed by the processor 1610, whereby the user equipment is operative to: identify, e.g. in a service module, selected usage of an electronic book, to determine, e.g. in a determining module, whether insertion of a tag and associated annotation is selected; identifying, e.g. in an identifying module, a selected annotation accordingly. The user equipment may also be operative to enable editing of the annotation, e.g. in an editing module.

In order to be able to render, or consume, an electronic book, the user equipment is further operative to identify sections of media content of the electronic book, e.g. in a media content module, and present the content to the user via a suitable presentation means, which may include presentation via a display, a loudspeaker or a combination thereof.

In addition, the user equipment is operative to handle tags and annotations inserted into an electronic book, by determining, e.g. in an annotation module, for a rendered section of media content, whether there is at least one tag available for that section and by acquiring an associated annotation, if selected by the user, and present it to the user, via one or more presentation units.

Furthermore, the user equipment is typically also operative, in the service module or any other module adapted therefore to identify a usage change selected by the user whenever this is found to be required, and to notify the annotation server of such a change.

In case of a hardware implementation, the processor 1610 may instead of software modules be arranged as corresponding interacting hardware units, implemented as logic on one or more processors.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method for providing to a user equipment a version of an electronic book comprising media content provided as sequentially arranged sections and including a tag, said tag being representative of an associated annotation that comprises additional media content, the method comprising:
identifying, in a request received from a first user equipment, a first version of an electronic book, an additional version of the electronic book, a first end user and the first user equipment as a user equipment on which an end user requires presentation of the electronic book;
synchronizing the media content of the first version of the electronic book and the tag with associated content of said additional version of the electronic book, and
identifying and transmitting, sequentially, to the first user equipment, media content of the first version of the electronic book together with any identified associated tag, wherein,
in response to identifying a request received from the first user equipment indicating a selection of said tag, the method further comprises: identifying and transmitting, to a preferred user equipment, an annotation associated with the selected tag, such that the annotation can be presented to an end user using the preferred user equipment.

2. The method of claim 1 further comprising:
identifying, upon receiving a request for selecting a preferred user equipment, the first user equipment as a preferred user equipment.

3. The method of claim 1 further comprising:
identifying, upon receiving a request for selecting a preferred user equipment, a second user equipment as a preferred user equipment.

4. A method for enriching content of an electronic book, said electronic book comprising media content provided as sequentially arranged sections, the method comprising:
identifying a first version of the electronic book, a first user device on which an end user has initiated presentation of the electronic book, and the first end user, and
identifying and transmitting, sequentially, to the first user equipment, media content of the first version of the electronic book, wherein,
in response to identifying a user interaction executed at the first user equipment and associated with a section of the first version, indicative of associating a tag and an associated annotation with said section, the method further comprises:
associating the identified tag and an associated annotation with the selected section, such that, after a subsequent synchronization of the media content of the first version of the electronic book and the identified tag with associated media content of at least one additional version of the electronic book, the specified tag and associated annotation is presentable and selectable in association with presenting the selected section on the first version and the at least one additional version of the electronic book on a respective user equipment.

5. The method of claim 1, wherein said synchronization is based at least partly on access rights registered for the first end user.

6. The method of claim 1, wherein said synchronization is based at least partly on at least one of the following identified attributes: the first end user, the one or more additional versions of the electronic book, a group of end users.

7. The method of claim 1, further comprising:
increasing a counter associated with the first end user upon identifying a selection of an annotation previously associated by the first end user and selected by an end user other than the first end user, or
decreasing the counter on the basis of the media content comprised in an annotation selected by the first end user and previously associated by an end user other than the first end user.

8. A computer program comprising computer program code, the computer program code being configured such that when executed on a processor, the processor is caused to implement the method of claim 1.

9. A computer program product comprising a computer readable storage medium, the computer readable storage medium having the computer program of claim 8 embodied therein.

10. A server for providing, to a user equipment, an electronic book, the electronic book comprising media content provided as sequentially arranged sections and including at least one tag, each of which is being representative of an associated annotation, where each annotation comprises additional media content, the server comprising: a processor, and a memory, said memory comprising instructions executable by said processor, whereby said server is operative to:
identify, in a request received from a first user equipment via a communication interface, a first version of an electronic book, at least one additional version of the electronic book, a first end user and the first user equipment as a user equipment on which an end user requires presentation of the electronic book;
initiate synchronization of the media content of the first version of the electronic book and the at least one tag with associated content of said at least one additional version of the electronic book, and
identify and sequentially transmit, via the communication interface, to the first user equipment, media content of the first version of the electronic book together with any identified associated tag, wherein,
in response to identifying a request received from the first user equipment indicating a selection of one of said tags, the server is further operative to:
identify and transmit, via the communication interface, to a preferred user equipment, an annotation associated with the selected tag, such that the annotation can be presented to the end user on the preferred user equipment.

11. The server of claim 10 wherein the server is further operative to identify, upon receiving a request for selecting a preferred user equipment, at least one second user equipment as a preferred user equipment.

12. A server for providing, to a user equipment, an electronic book, the electronic book comprising media content provided as sequentially arranged sections and including at least one tag, each of which is being representative of an associated annotation, where each annotation comprises additional media content, the server comprising: a processor, and a memory, said memory comprising instructions executable by said processor, whereby said server is operative to:
identify, in a request received from a first user equipment via a communication interface, a first version of the electronic book, a first user equipment on which an end user has initiated presentation of the electronic book, and the first end user, and
identifying and transmitting, sequentially, to the first user equipment, media content of the first version of the electronic book, wherein,
in response to identifying a user interaction executed at the first user equipment and associated with a section of the first version, indicative of associating a tag and an associated annotation with said section, the server is further operative to:
associate the identified tag and an associated annotation with the selected section, such that, after a subsequent synchronization of the media content of the first version of the electronic book and the identified tag with associated media content of at least one additional version of the electronic book, the specified tag and associated annotation is presentable and selectable in association with presenting the selected section on the first version and the at least one additional version of the electronic book on a respective user equipment.

13. The server of claim 12, wherein the server is further operative to perform the synchronization at least partly on the basis of access rights registered for the first end user.

14. The server of claim 12, wherein the server is further operative to perform the synchronization at least partly on the basis of at least one of the following identified attributes: the first end user, the one or more additional versions of the electronic book, a group of end users.

15. The server of claim 12, the server further comprising a counter associated with the first user, the server being operative to increase the counter upon identifying a selection of an annotation previously associated by the first end user and selected by an end user other than the first end user, and to decrease the counter upon identifying a selection of an annotation being made by the first end user where the selected annotation is previously associated by an end user other than the first end user.
